(19) United States
(12) Patent Application Publication
(10) Pub. No.: US 2008/0018654 A1
(43) Pub. Date: Jan. 24, 2008

(54) Writing board device having high-definition image display function

(76) Inventor: Hae-Yong Choi, Seoul-City (KR)

Correspondence Address: BACON & THOMAS, PLLC, 625 SLATERS LANE, FOURTH FLOOR, ALEXANDRIA, VA, 22314, US

(21) Appl. No.: 11/798,358

(22) Filed: May 14, 2007

(30) Foreign Application Priority Data
Jun. 29, 2006 (KR) 20-2006-0017906

(51) Int. Cl. G06F 3/033

(52) U.S. Cl. 345/536

(57) ABSTRACT

A writing board device having a high-definition image display function is disclosed. The writing board device includes a main body, a screen device which has a glass panel provided at an upper front portion of the main body and an image forming part provided at a rear surface of the glass panel, the image forming part being formed in a thin film shape, a projector which is provided at a bottom of the main body, and a screen illumination device which is provided at rear of the screen device, the screen illumination device having a projection lens, a color filter and a lamp. Accordingly, the writing board device allows a user to write letters freely on the screen device while displaying the image with a higher definition by two times or more as compared with a conventional device. When the image display is not needed, the writing board device serves as a writing board capable of showing the written letters with a higher definition by two times or more as compared with a conventional device.

### BACKGROUND OF THE INVENTION

1. Field of the Invention

The present invention relates to a writing board device having a high-definition image display function which cannot only allow a user to write thereon like a blackboard but also can display an image. The writing board device is provided with a screen which has a glass panel and an image forming part in an integral manner so that an image formed on the image forming part is transmitted forward by a refractive index of the glass panel to generate a high definition image, and a screen illumination device which illuminates written letters on the glass panel from the rear to give the written letters definition. More particularly, the present invention relates to a writing board device having a high-definition image display function in which a screen itself functions as a writing board and an image can be displayed through the screen while increasing definition of an image and letters by two times or more as compared with a conventional device.

2. Description of the Related Art

Generally, in conferences or lectures, there are many occasions of displaying a computer image or a video image, and putting a mark or writing on the image.

A conventional writing board device capable of writing on an image forming part is configured to write on a touch board or a writing monitor to input written letters or marks to a projector, and to display the letters or the marks through a screen.

Because the conventional writing board device should be equipped with an additional electronic pen, it is difficult to write a good hand and the writing itself is inconvenient. Also, the conventional device has a complicated structure due to many electronic components such as a writing monitor, a computer and the like, and manufacturing cost is high.

Another exemplary conventional writing board device configured to project an image to a surface of a whiteboard has a problem that a writer blocks the projected image. The whiteboard itself is needed to have a high hardness so that the writer can write with a whiteboard pen and erase the written letters. However, the hard whiteboard has a limitation that the image on the surface of the whiteboard is indistinct.

Further, as the writing and erasing is performed over and over, the whiteboard is contaminated more and more by the ink of the pen absorbed in the whiteboard, thereby deteriorating the image definition.

### SUMMARY OF THE INVENTION

Therefore, the present invention has been made in view of the above problems, and it is an object of the present invention to provide a writing board device having a high-definition image display function which can prevent contamination of a surface of a screen due to the ink of a pen.

It is another object of the present invention to provide a writing board device having a high-definition image display function which can prevent an image from being blocked by a writer by projecting the image from the rear of a screen.

It is a further object of the present invention to provide a writing board device having a high-definition image display function which is provided with a screen illumination structure to give written letters definition.

It is yet another object of the present invention to provide a writing board device having a high-definition image display function in which an image can be displayed through a screen while increasing definition of an image and letters by two times or more as compared with a conventional device.

In accordance with the present invention, the above and other objects can be accomplished by the provision of a writing board device having a high-definition image display function comprising: a main body; a screen device which has a glass panel provided at an upper front portion of the main body and an image forming part provided at a rear surface of the glass panel, the image forming part being formed in a thin film shape; a projector which is provided at a bottom of the main body; and a screen illumination device which is provided at rear of the screen device, the screen illumination device having a projection lens, a color filter and a lamp.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a writing board device having a high-definition image display function in accordance with the present invention;

FIG. 2 is a sectional view illustrating a writing board device having a high-definition image display function in accordance with the present invention;

FIG. 3 is a constitutional view of a screen device of a writing board device having a high-definition image display function in accordance with the present invention;

FIG. 4 is a schematic view illustrating operation of a projector when a writing board device serves as an image display device;

FIG. 5 is a schematic view illustrating operation of an illumination lamp when a writing board device serves as a writing board;

FIG. 6 is a schematic view illustrating operation of a screen illumination device when a writing board device serves as a writing board; and

FIG. 7 is a sectional view illustrating a writing board device having a high-definition image display function in accordance with the present invention when a screen illumination device and a projector are operated.

### DETAILED DESCRIPTION OF THE PREFERRED EMBODIMENTS

Now, preferred embodiments of the present invention will be described in detail with reference to the annexed drawings.

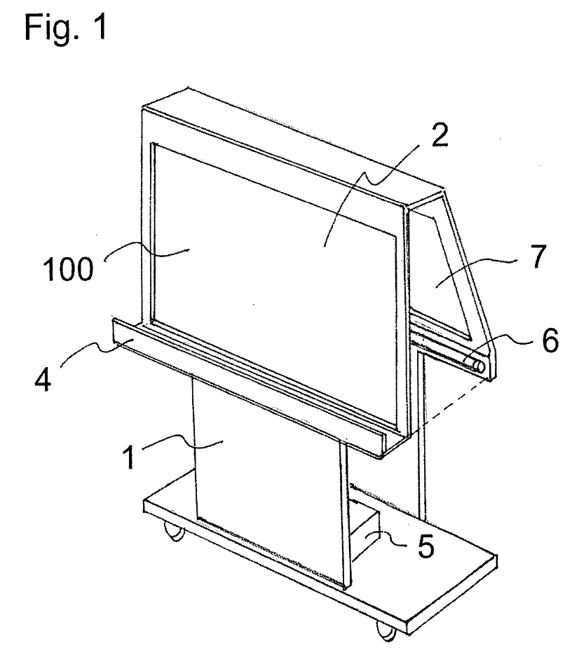

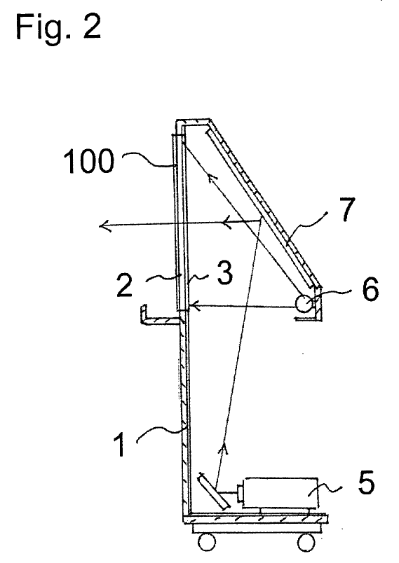

As shown in FIGS. 1 and 2, a writing board device having a high-definition image display function according to the present invention includes a main body 1, a screen device 100 mounted to an upper front portion of the main body 1, a mirror 7 provided at rear of the main body 1, and a projector 5 provided under the mirror 7.

A supporting frame 4, on which writing instruments are put, is formed at a lower front surface of the screen device 100.

An image projected from the projector 5 provided at the bottom in the main body 1 is reflected by the mirror 7 provided above the projector 5, and formed on the screen device 100.

In such a present invention, the screen device 100 is a very important component.

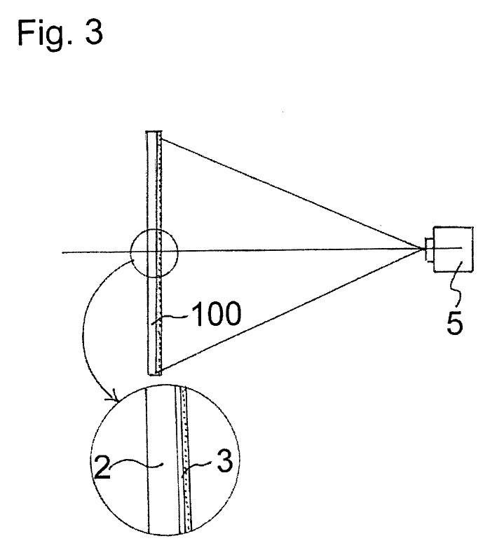

As shown in FIG. 3, the screen device 100 includes a glass panel 2 provided at the upper front portion of the main body 1 and an image forming part 3 provided at a rear surface of the glass panel 2. The image forming part 3 is formed in a thin film shape so that the image projected from the projector 5 can be formed on the image forming part 3 and transmitted forward through the image forming part 3.

Because the image projected from the projector 5 and formed on the image forming part 3 is transmitted forward by a refractive index of the glass panel 2, a transmittance of the image is increased. Further, because the glass panel 2 has an effect of minimizing reflection of external light by its own material features, the definition of the image is increased by two times or more as compared with a conventional device.

Preferably, the image forming part 3 is configured as a scattering surface with a thickness of about 1 μm to about 300 μm. If the thickness of the scattering surface is larger than 300 μm, the image formed on the image forming part 3 cannot be transmitted and is intercepted.

The image forming part 3 may be formed by attaching a thin transmission scattering film to the rear surface of the glass panel 2 or performing ultrasonic surface treatment on the rear surface of the glass panel 2.

Preferably, the scattering particle size of the rear surface of the glass panel 2 is 60 mesh or more. If the scattering particle is rough such that the size is less than 60 mesh, a so-called pinhole phenomenon that the image extraordinarily glitters happens, thereby deteriorating the definition of the image.

From a point of view that the purpose of the present invention is to provide a writing board device capable of being used in bright places for conference or lecture, the high-definition image is one of the most important conditions to be satisfied.

As described above, since the screen is made of glass, water based ink or oil based ink of the writing instruments is not absorbed in the screen, and so the contamination of the screen can be prevented. Accordingly, even though the writing and erasing is performed over and over, the definition of the image formed on the image forming part 3 at the rear surface of the glass panel 2 can be kept high.

In addition, if a color of the image forming part 3 is set to be a dark tone like black or navy blue, since the contrast is further increased with respect to the external light, the definition of the image can be increased by two times or more as compared with a conventional device.

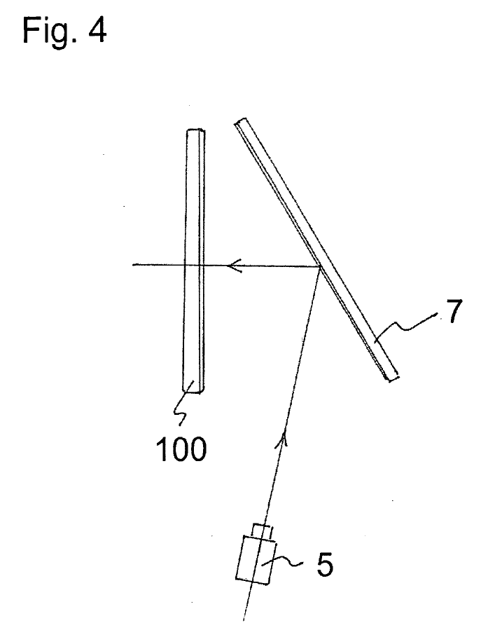

However, the screen device 100 of a dark color has a disadvantage that the letters or the marks written on the surface of the glass panel 2 can be seen clearly only when illuminating the glass panel 2 from the rear of the glass panel 2 as shown in FIG. 4.

If the light for illuminating the glass panel 2 is emitted only from a light source of the projector 5, the lifespan of the projector 5 is shortened.

Also, because water based ink or oil based ink of the writing instruments for writing on the glass panel 2 is generally transparent, if the rear side of the glass panel 2 is dark, the letters or the marks written on the glass panel 2 are also dark, so that the letters or the marks become invisible.

Although the writing instruments with opaque ink are used, observers cannot see the written letters or marks well because of the dark background.

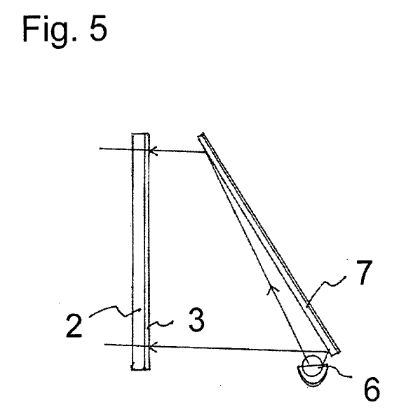

To solve this problem, as shown in FIG. 5, the present invention is further provided with an illumination lamp 6, which is disposed under the mirror 7.

When the writing board device of the present invention is intended to be used only as a writing board, the projector 5 is turned off, and the illumination lamp 6 is turned on. In this case, since the illumination lamp 6 brightly illuminates the screen device 100 from the rear, the definition of the letters or the marks written on the surface of the glass panel 2 can be increased (by two times or more as compared with a conventional writing device).

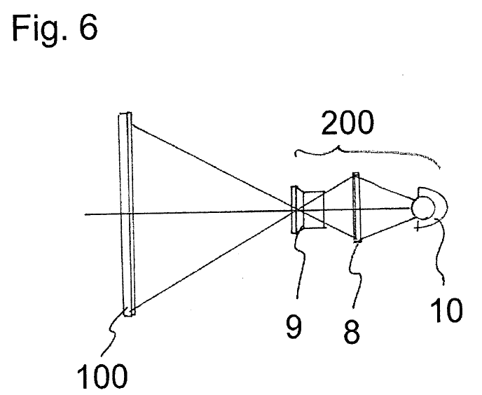

As shown in FIG. 6, the illumination lamp 6 may be embodied in a screen illumination device 200 which includes a lamp 10, a color filter 8 disposed in front of the lamp 10, and a projection lens 9 disposed in front of the color filter 8. The light emitted from the lamp 10 is irradiated toward the image forming part 3 through the color filter 8 and the projection lens 9.

Such a screen illumination device 200 has an effect of illuminating the image forming part 3 with a more uniform brightness than the general illumination lamp 6 depicted in FIG. 5.

Also, for example, if a green filter is used as the color filter 8, the whole area of the screen device becomes green. Accordingly, the writing board device of the present invention serves as a blackboard capable of decreasing the observer's eye fatigue.

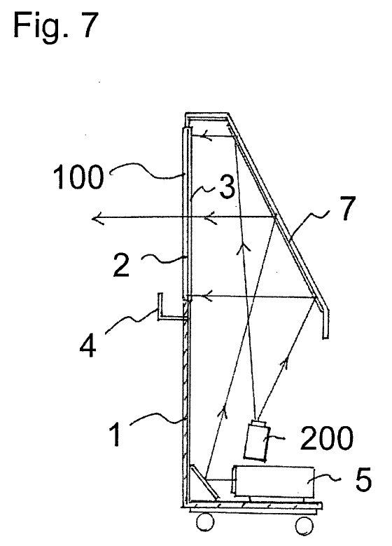

For convenience in usage, the writing board device of the present invention may be modified such that the screen illumination device 200 is positioned near the projector 5 as shown in FIG. 7 and the projector 5 and the screen illumination device 200 are selectively operated by a changeover switch. In other words, when the projector 5 is turned off, the screen illumination device 200 is automatically turned on, and when the screen illumination device 200 is turned off, the projector 5 is automatically turned on. By such a modification, the writing board device according to the present invention can be conveniently selected to serve as a writing board or to serve as an image display device.

As apparent from the above description, the writing board device having the high-definition image display function according to the present invention is provided with the glass panel and the image forming part having a thin film shape and provided at the rear surface of the glass panel, so that the image formed on the image forming part can be transmitted forward by a refractive index of the glass panel without interference of external light and any medium, thereby increasing the transmittance and the definition of the image by two times or more as compared with a conventional device.

Also, since the glass panel has features of preventing contamination by blocking the absorption of water based ink or oil based ink of writing instruments, the image can be always transmitted clearly through the glass panel.

Also, since the image formed on the screen device having a dark color is not affected by external light, it is possible to provide the high-definition image in bright places.

Also, the letters written on the surface of the screen device can be shown more clearly by providing the illumination lamp or the screen illumination device having the projection lens, the color filter and the lamp so as to illuminate the screen device from the rear.

Conclusively, the writing board device having the high-definition image display function according to the present invention allows a user to write letters or marks freely on the screen device while displaying the image with the higher definition by two times or more as compared with a conventional device. Furthermore, when the image display is not needed, the writing board device according to the present invention serves as a writing board capable of showing the written letters or marks with the higher definition by two times or more as compared with a conventional device.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A writing board device having a high-definition image display function comprising:
a main body;
a screen device which has a glass panel provided at an upper front portion of the main body and an image forming part provided at a rear surface of the glass panel, the image forming part being formed in a thin film shape;
a projector which is provided at a bottom of the main body; and
a screen illumination device which is provided at rear of the screen device, the screen illumination device having a projection lens, a color filter and a lamp.

2. A writing board device having a high-definition image display function comprising:
a main body;
a screen device which has a glass panel provided at an upper front portion of the main body and an image forming part provided at a rear surface of the glass panel, the image forming part being formed in a thin film shape and the screen device having a dark color;
a projector which is provided at rear of the screen device; and
an illumination lamp which is provided at rear of the screen device.

3. A writing board device having a high-definition image display function comprising:
a main body;
a glass panel which is provided at an upper front portion of the main body;
an image forming part which is provided at a rear surface of the glass panel, the image forming part being formed in a thin film shape;
an illumination lamp which is provided in the main body; and
a projector which is provided at a bottom in the main body.

4. The writing board device according to claim 3, wherein the image forming part has a dark color.

5. The writing board device according to claim 3, further comprising:
a projection lens and a color filter which are provided in front of the illumination lamp.
